(19) United States
(12) Patent Application Publication
(10) Pub. No.: US 2003/0018256 A1
(43) Pub. Date: Jan. 23, 2003

(54) Therapeutic ultrasound system

(76) Inventors: Kazuaki Sasaki, Kawasaki (JP); Takashi Azuma, Kodaira (JP); Ken-Ichi Kawabata, Kodaira (JP); Shin-Ichiro Umemura, Hachioji (JP)

Correspondence Address: MATTINGLY, STANGER & MALUR, P.C., 1800 Diagonal Road, Suite 370, Alexandria, VA, 22314, US

(21) Appl. No.: 10/075,284

(22) Filed: Feb. 15, 2002

(30) Foreign Application Priority Data
Jul. 23, 2001 (JP) 2001-221987

(51) Int. Cl. A61H 1/00

(52) U.S. Cl. 600/439

(57) ABSTRACT

Disclosed is a system for detecting whether a tissue of in the vicinity of a focal point region reaches a temperature at which the tissue is altered thermally in an ultrasound thermal coagulation therapy, and for securing an effect of the therapy. The system includes: irradiating means for irradiating an ultrasound for ultrasound therapy; a signal detection unit for detecting bubble generation in a region to be treated; and a control circuit for controlling a continuous insonation time of a therapeutic ultrasound upon receiving information from the signal detection unit.

### BACKGROUND OF THE INVENTION

1. Field of the Invention

The present invention relates to a therapeutic ultrasound system, more particularly to a therapeutic ultrasound system combined with a detector for detecting generation of a bubble in a treated region under treatment.

2. Descriptions of the Related Arts

An ultrasound has a feature that a laser beam and an electromagnetic wave such as a microwave do not have. Specifically, the ultrasound has the feature in that it propagates to the depths of a living body with a wavelength by far the shorter than a dimension of a human body and can be converged on an arbitrary spot. Research and development on an ultrasound therapy making good use of this feature has been enthusiastically progressed.

A bioeffect that can be utilized in the therapy is broadly divided into a thermal effect and a sonochemical effect. The thermal effect as the former effect originates from a phenomenon that a tissue absorbs an ultrasound to generate heat. The therapy to which the thermal effect is clinically applied can be broadly divided into “hyperthermia,” in which a tumor or the like is treated by continuously heating an affected area at about 40 to 50° C., and “thermal coagulation therapy,” in which a high intensity focused ultrasound is used to heat up a micro-region of an affected area to a temperature causing tissue alteration, for example, 70 to 100° C., in a short time.

The “hyperthermia” for a tumor is a therapy utilizing a characteristic of a tumor cell in that it is weak under a continuous high temperature (about 43° C.) compared with a normal cell. Although the hyperthermia can slow down growth of the tumor, it has only a low capability of directly necrosing the tumor cell in a radical manner. Moreover, since temperature increase of the affected area is controlled by a bloodstream and heat conduction of a peripheral tissue, it is not easy to maintain a temperature required for the therapy. Furthermore, localization of a region where temperature is increased is insufficient. Accordingly, the hyperthermia has not reached a satisfactory level in such a point that a balance between a treatment effect and a stress (side-effect) to a living body is no good. In an actual clinic, the hyperthermia is frequently used for a combination therapy with radiotherapy.

Meanwhile, the “thermal coagulation therapy” is a therapy that has been spotlighted again in recent years. In the thermal coagulation therapy, high intensity ultrasounds are converged onto a micro-region having a size in a millimeter unit, and the region is instantaneously heated up to the temperature causing the tissue alteration. The thermal coagulation therapy is different from the hyperthermia in the temperature increased in an objective spot for the therapy and a tissue change originating therefrom. Heat generated in the tissue is conveyed away therefrom by the heat conduction and the bloodstream. In the case of the thermal coagulation therapy, temperature of a focused area is increased more than a protein coagulation temperature by the high intensity ultrasound in by far the shorter time than a time required for the above-described heat transport and the heat generated by the ultrasound to reach an equilibrium state (about one minute), and thus the objective spot is coagulated.

As one of diseases for which the ultrasound therapy is suitable, benign prostatic hyperplasia (BPH) is enumerated. The BPH is a general disease in males of an age of 50 or more, in which hypertrophy and expansion of a prostate tissue press and occludes a urethra, thus causing dysuria and impotence. In an early stage of the BPH, a patient feels dysphoric, urine residual and inconvenient. Heretofore, as therapies less invasive for the BPH, trials have been made for therapies by a variety of non-surgical or surgical theoretical methods. Among them, transurethral resection of prostate (TUR-P) has been widespread in recent years, in which a resectoscope is inserted through an intraurethral cavity, and a hypertrophic prostate tissue is resected by use of an electric cautery. Now, the TUR-P has been used not only for the therapy of the prostate but also for a therapy of bladder cancer. While the TUR-P is an excellent surgical therapy, bleeding during or after surgery, perforation of prostate capsule, postoperative infection or the like is observed as a complication. Therefore, pursuit of safer low invasive therapy is required. Other low invasive therapies using a laser beam and a microwave are inferior to the TUR-P in availability. Accordingly, development of a method having a high availability and a less side-effect than the TUR-P is desired.

Moreover, prostatic cancer has been increased in recent years as the BPH has been increased. In an early stage thereof, the prostatic cancer can be treated successfully by the TUR-P. However, similarly to the treatment of the BPH, a complication such as bleeding is involved therein, and there is a high risk of bringing a sequela such as incontinence and impotence. While the prostatic cancer can be treated by radiotherapy, preparation must be made for a serious side-effect with a dose sufficient for obtaining a good treatment effect. Further, progressed prostatic cancer can be also an object of the radiotherapy. However, the prostatic cancer cannot be usually cured completely even if symptoms thereof can be absorbed. Since an effect achieved in the case as described above is small, a more noninvasive method is further required.

A transrectal thermal coagulation therapy that has made an appearance in recent years is conceived as a good example in which the above-described thermal coagulation therapy is applied to the treatment of the BPH and the prostatic cancer. This therapy utilizes an anatomical characteristic that the prostate is adjacent to a rectal wall, in which an applicator capable of generating a high intensity focused ultrasound is inserted into an intrarectal cavity, and the ultrasound is converged on the prostate adjacent to the applicator with the rectal wall interposed therebetween, thus the inside of the prostate is subjected to the thermal coagulation. For example, in the case of the BPH, a hypertrophic tissue pressing a urethra from a periphery thereof is subjected to the thermal coagulation, and a necrosed tissue of the hypertrophic tissue is dropped, thus a cavity is formed in a urethra portion of the prostate. Consequently, the urethra portion of the prostate is expanded, thus improving the dysuria for a long period of time. Moreover, similarly to the case of the prostatic cancer, the tissue of the prostatic cancer is subjected to the thermal coagulation, thus making it possible to retract the prostatic cancer and to suppress the growth thereof. Recently, a lot of clinical cases using the transrectal thermal coagulation therapy have been reported and the transrectal thermal therapy has attracted attention as a therapy having an excellent concept in that the treatment of the BPH and the prostatic cancer can be carried out non-invasively.

Meanwhile, with regard to the thermal coagulation therapy, besides application to the prostate as described above, application thereof to various diseases has been examined. As a treatment mode analogous to the prostate therapy by the transrectal approach, a trial has been started, in which an applicator for the ultrasound therapy is inserted into an abdominal cavity under endoscopic surgery, and the applicator is made close to the vicinity of an organ of an abdomen such as a liver and a kidney, thus a hepatoma or a nephroma is treated. Moreover, a therapy by a focused-ultrasound exposure from an outside of a body has been hitherto tried as a mode of percutaneously treating the organ of the abdomen, mainly the liver and the kidney.

### SUMMARY OF THE INVENTION

In the thermal coagulation therapy, a region where an irreversible thermal alteration of the tissue is generated by exposure of the focused ultrasound has a very small volume in the vicinity of a focal point (including the focal point itself). This is because a density of the ultrasound is low in spots other than the focal point and the spots do not reach a temperature of the thermal alteration. This is advantageous from the viewpoint of avoiding the side-effect. However, since a region for which the treatment can be carried out at a time is small, there is a problem that a total time for the treatment becomes long when a broad region must be treated. This is because it is difficult to avoid the side-effect if a wait is not made for sufficient lowering of the temperature of the tissue other than the treatment object by a cooling effect of a bloodstream or the like in the event of shifting to the next exposure, the temperature having been increased in the previous exposure. Meanwhile, even if the ultrasound intensity applied to treat the broad region at a time is increased, the region treatable at a time cannot be broadened significantly, and the side-effect to the tissue other than the region desired to be treated is caused significantly, thus leading to a risk. Hence, under the current situation, the treatment efficiency is significantly inferior.

Meanwhile, when the tissue of the living body is exposed with an intense focused ultrasound, as described above, the radical temperature increase due to the absorption of the ultrasound in the tissue occurs in the vicinity of the focal point (including the focal point itself) where the ultrasound density is high, and the temperature in the tissue of the focal point region is increased to 70 to 100° C. In this case, bubbles having water vapor as a main component are generated radically in the tissue of the focal region due to the high temperature. The bubbles reflect the ultrasound intensely. Furthermore, among the bubbles, there is a bubble causing a cavitation phenomenon in an ultrasound field, where harmonics and subharmonic components of the irradiated ultrasound are generated.

As described above, when the bubbles are generated in the focal point region, the irradiated ultrasound is reflected by the bubbles. Thus, the absorption of the ultrasound in front of the focal point region where the bubbles are generated is increased. Consequently, the temperature increase in the vicinity of the focal point (including the focal point itself) and in front thereof from the time of generation of the bubbles is radically promoted as compared with the time prior to the generation of the bubbles. When such a characteristic of promoting the thermal coagulation of the tissues in the vicinity of the focal point (including the focal point itself) and in front thereof due to the generation of the bubbles is used for the treatment, it is conceived that the coagulated region is expanded to increase the treatment effect. However, there are problems as below.

Consideration will be made for the case where the ultrasound exposure is carried out plural times. Then, the previous temperature increase of the tissue in the vicinity of the object tissue of the concerned exposure cannot be ignored. Moreover, a difference occurs in a state where the bubbles are generated in the focal point region due to a difference in a tissue even if the ultrasound intensity and the exposure time are equal. For example, when consideration is made for the case of performing the treatment under a program that each exposure time is five seconds, bubble generation is observed within five seconds in some cases, and in other cases, the bubbles do not come to be generated within five seconds. In the former case, when the bubbles are generated on the way of exposure, for example, at a stage of four seconds, the ultrasound exposure continues under the existence of the bubbles for a remaining one second, thus the coagulation effect is radically promoted to generate the coagulation of the tissues in a broad region. Meanwhile, in the latter case, since the bubbles are not generated during the exposure for five seconds, the coagulated region becomes small as compared with the former case, thus a difference occurs between the coagulated regions of the former and latter cases. This matter means that it is impossible to predict an effect in the case where the treatment is carried out for the broad affected area by scanning the focused ultrasound.

An object of the present invention is to provide means for securing the thermal coagulation, in which it is possible to freely set a continuous insonation time of the ultrasound for treatment from the point of time when the temperature causes the bubble generation in the focal point region, that is, when the temperature reaches a point capable of securely subjecting the tissue to the thermal alteration.

In the present invention, the foregoing object in the local ultrasound therapy for a disease region including a tumor and a cancer is achieved by imparting, to a therapeutic ultrasound system, a function capable of freely setting the continuous insonation time of the focused ultrasound from the point of time when the bubbles are generated in an area irradiated with the ultrasound for treatment. Thanks to this function, even if periods of time for the bubble generation in the respective ultrasound exposures are different in the event where the ultrasound for treatment is irradiated plural times, the continuous insonation time of the ultrasound from the time of the bubble generation is always kept constant, thus making it possible to secure the coagulation effect of each time without increasing the intensity of the ultrasound to be applied. Meanwhile, if the continuous insonation time of the ultrasound from the bubble generation is set constant as described above, also in the case where the bubble generation is progressed faster than expected in the plural times of insonation, the ultrasound exposure is finished in a set period of time from the bubble generation; therefore, it is also made possible to suppress the emergence of the side-effect due to overheat.

Specifically, the therapeutic ultrasound system according to the present invention includes: an ultrasonic transducer for irradiating a therapeutic ultrasound on a region to be treated; setting-up means for setting up an insonation time of the therapeutic ultrasound; and bubble detecting means for detecting a bubble caused in a region exposed with the therapeutic ultrasound during exposure of the therapeutic ultrasound. The setting-up means has a function of setting up a time from detection of the bubble by said bubble detecting means to the end of the exposure of said therapeutic ultrasound. The setting-up means can also carry out setting so that the irradiation of the therapeutic ultrasound can be finished simultaneously with detection of the bubbles.

The bubble detecting means can be set to have means for detecting harmonics of the therapeutic ultrasound such as an acoustic wave having a frequency twice a center frequency of the therapeutic ultrasound transmitted from the ultrasonic transducer.

The bubble detecting means can include: means for receiving a reflected wave including the harmonics of the therapeutic ultrasound transmitted from the ultrasonic transducer; signal processing means for reconstituting an image of the bubble by processing a received signal; and displaying means for displaying the image of the bubble, which is reconstituted by the signal processing means.

The displaying means may display the received signal intensity of the harmonics of the therapeutic ultrasound on a position on the screen, which corresponds to a detected position thereof. Moreover, the displaying means may display a signal intensity ratio of the received signal intensity of the harmonics of the therapeutic ultrasound and preset reference signal intensity.

It is effective in terms of safety to provide means for generating an alarm when the received signal intensity of the harmonics of the therapeutic ultrasound reaches a set value or more.

Moreover, a therapeutic ultrasound system according to the present invention includes: an ultrasonic transducer for irradiating a therapeutic ultrasound on a region to be treated; and means for detecting an audible sound generated in a region exposed with the therapeutic ultrasound during exposure of the therapeutic ultrasound, and a function of setting up a time from detection of the audible sound to the end of the exposure of said therapeutic ultrasound is provided. Simultaneously with the detection of the audible sound, the irradiation of the therapeutic ultrasound may be finished.

According to the present invention, the means for detecting a bubble or an audible sound is provided, which is generated in the region to be treated, and the continuous ultrasound insonation time from the time of detecting the bubble or the audible sound can be arbitrarily set. Accordingly, without increasing the intensity of the therapeutic ultrasound to be introduced, the continuous time can be controlled, when the ultrasound propagating through the tissue of the affected area is substantially increased to enhance the ultrasound absorption. Consequently, it is made possible to secure the treatment effect for each irradiation.

According to the present invention, it is made possible to freely set the continuous insonation time of the therapeutic ultrasound from the point of time when the temperature reaches a point of causing the bubble generation in the focal point region, thus enabling the thermal coagulation to be secured. Specifically, there is provided the function of enabling the continuous insonation time of the focused ultrasound from the bubble generation in the region exposed with the therapeutic ultrasound to be freely set. Thus, in the event of performing the irradiation of the therapeutic ultrasound plural times, the continuous insonation time from the bubble generation is always kept constant even if the period of time taken for each bubble generation differs from those for other generations, whereby it is made possible to secure the coagulation effect of each time of irradiation without increasing the intensity of the applied ultrasound. Moreover, if the continuous insonation time from the bubble generation is set constant as described above, also in the case where the bubble generation is progressed faster than expected in the plural times of irradiation, the ultrasound irradiation is finished in the set period of time from the bubble generation; therefore, it is also made possible to suppress the emergence of the side-effect due to overheat.

### BRIEF DESCRIPTION OF THE DRAWINGS

FIG. 1 is a view showing one example of a transrectal prostate treatment according to the present invention.

FIG. 2 is an image view of a sectional ultrasound image of a prostate observed transrectally.

FIG. 3 is a view showing a time base waveform of a sound detected from a spot treated.

FIG. 4 is a view showing an FFT spectrum of the sound detected from the spot treated.

FIG. 5 is a view showing a temperature increase in a tissue due to ultrasound exposure.

FIG. 6 is a schematic view showing reflection of the ultrasound due to bubbles in the tissue.

FIG. 7 is a view showing one example of an ultrasound therapy under an endoscopic surgery according to the present invention.

FIG. 8 is a view showing a method for irradiating an ultrasound for treatment.

FIG. 9 is a view showing control of a continuous insonation time in the event of plural times of insonation.

### DETAILED DESCRIPTION OF THE PREFERRED EMBODIMENTS

Embodiments of the present invention will be described with reference to the accompanying drawings below.

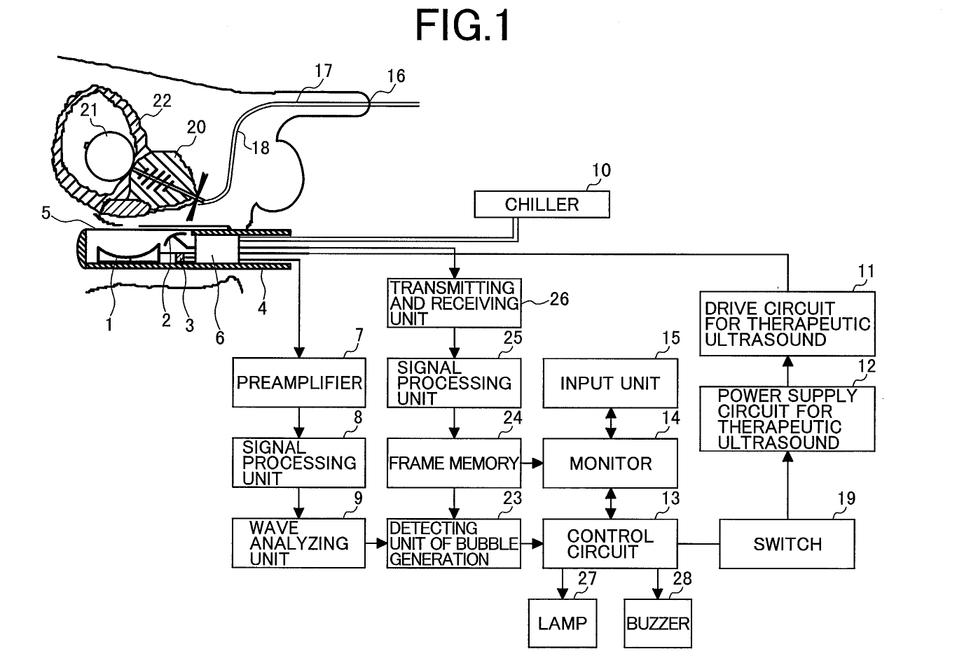

FIG. 1 is a block diagram showing a constitutional example of a therapeutic ultrasound system in prostate treatments, which is an embodiment of the present invention. A therapeutic applicator inserted in a rectum and placed so as to be close to a prostate 20 as a region to be treated with a rectal wall interposed therebetween holds a therapeutic ultrasound transducer 1, an ultrasound imaging probe 2 and a sound detection microphone 3 in an applicator overcoat 4, and is hermetically sealed by a liquid leakage prevention stopcock 6 and an applicator cover 5 so that a cooling medium can circulate therein. Herein, water as a substance offering an acoustic impedance akin to that of a living body is usually used as the cooling medium so as to enhance fitness of an ultrasound vibrator with the living body, and the cooling medium is subjected to degassing in order to prevent bubbles being generated by irradiation of an intense ultrasound and thus not to hinder transmission of the ultrasound. Moreover, in order to reduce influences of a temperature rise on a rectal mucosa, the medium in the applicator is cooled by a cooling water circulation unit 10 having a degassing function, and is allowed to circulate. The ultrasound imaging probe 2 disposed in the applicator performs observation of the periphery of an affected area and aiming at a therapeutic object, and plays a role of a guide for irradiation of a therapeutic ultrasound. Herein, in the transrectal prostate therapy described in this embodiment, in some cases, a urethral catheter 17 is inserted in a urethra 18 from a urethral opening 16, and then the urethal catheter 17 is allowed to reach the inside of a bladder 22 via a urethral portion in the prostate 20 and to remain therein. A balloon 21 in a tip of the catheter is expanded in the bladder, whereby the tip portion of the catheter is held in the bladder 22. Thus, it is possible to allow the catheter to securely remain in the bladder 22. Actually, when the ultrasound is irradiated on the prostate, inflammation and swelling of the prostate occur, thus affecting urination. As described above, by allowing the urethral catheter 17 to remain in the bladder, it becomes easy to control the urination for several days from the exposure.

The ultrasonic transducer 1 is driven by a drive circuit 11 for a therapeutic ultrasound and a power supply circuit 12 for the same so as to irradiate an intense ultrasound having a frequency, for example, from 1 MHz to 10 MHz. Concretely, the therapeutic ultrasound transducer 1 is composed of a plurality of electromechanical transducer elements such as piezoelectric elements, in which an amplitude and a phase of high frequency electric power applied to each element of the transducer can be controlled independently for each element. Information concerning the ultrasound exposure is inputted to a control circuit 13 by an operation of a key input unit 15. Based on the information, an exposure code signal for regulating a focal point and an acoustic pressure waveform of each exposed acoustic field, which accord with a selected frequency, is given from the power supply circuit 12 for the therapeutic ultrasound to the drive circuit 11 for the same.

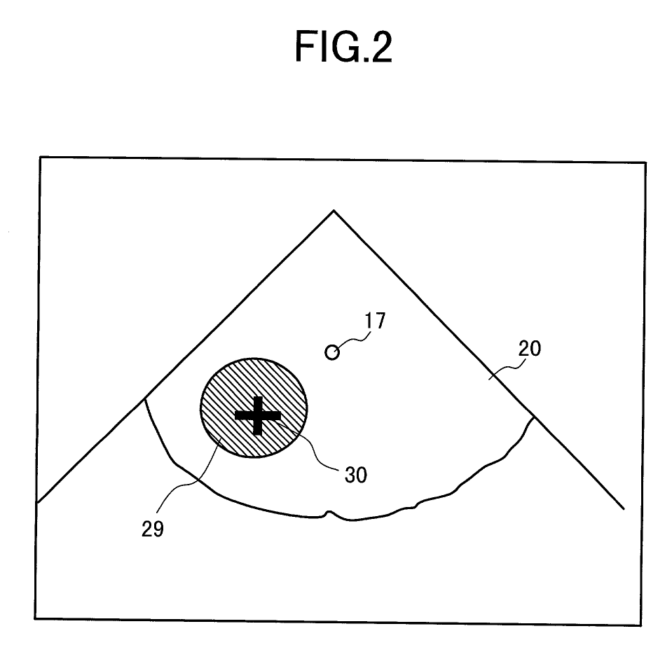

FIG. 2 is a schematic view of a sectional image of a prostate 20, which is obtained by use of the ultrasound imaging probe 2 provided with the applicator. By use of the ultrasound imaging probe 2, observation of a region to be treated is enabled, and a plurality of ultrasound pulse-echo sectional images required for positioning an object to be exposed can be obtained. A section of the urethral catheter 17 also appears on the sectional image of the prostate 20. By use of this sectional image, a region 29 to be treated can be observed. An alignment mark 30 indicating the focal point of the therapeutic ultrasound is displayed on the sectional image, thus facilitating the alignment thereof on the region desired to be treated. The ultrasound sectional image is observed, and the alignment is fixed by use of the alignment mark 30, then the region desired to be treated is exposed with the therapeutic ultrasound, thus the inside of the prostate is heated to be treated. The focused ultrasound is focused on the inside of the prostate and irradiated continuously from 0.1 second to 60 second per once in a range of 100 W/cm² to 100 kW cm² in a peak acoustic pressure around the focal point. This exposure is repeated while the applicator being properly moved, thus making it possible to treat the prostate 20.

When the therapeutic ultrasound is irradiated, bubbles composed mainly of water vapor are generated due to a radical temperature rise in the vicinity of the focal point (including the focal point itself) of the intense ultrasound, and the generated bubbles are radically expanded in the tissue; therefore, a sound including an audible sound range is generated. The sound is detected by the sound detection microphone 3, and an audio signal having passed through a preamplifier 7 is sent to a signal processing unit 8, where signal processing is carried out as below.

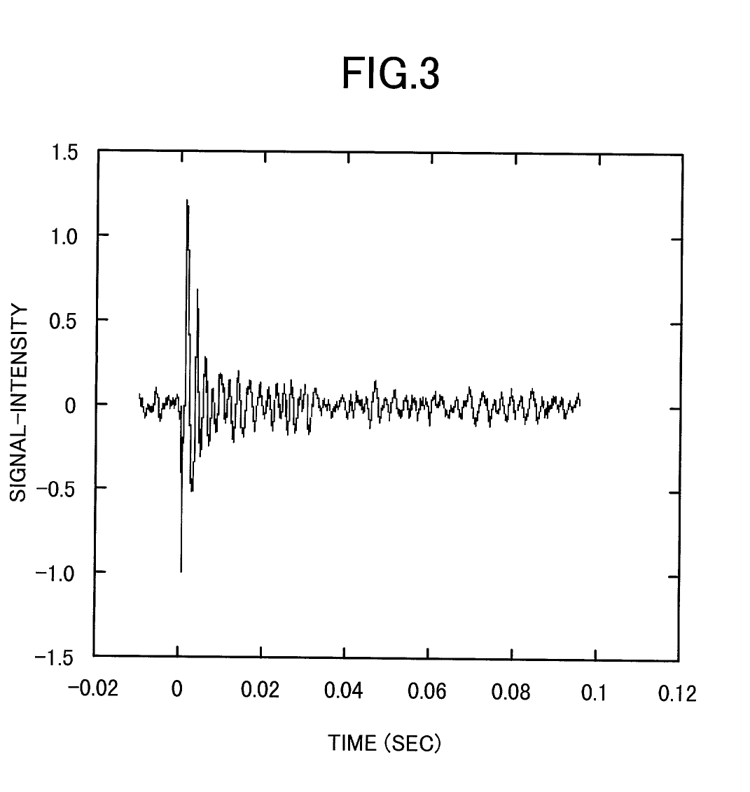

A waveform shown in FIG. 3 is one example of a time base waveform of a sound received during the generation of the bubbles. The sound received is subjected to suitable filtering processing and time cutting out processing in the signal processing unit 8. Then, in a waveform analyzing unit 9, obtained is a cross-correlation function between the waveform of the sound processed and a typical waveform of a sound detected during the generation of bubbles, which has been previously fetched.

### Expression 1

$$E x p r e s s i o n 1 ; \frac{max [ A ( t ) ⊗ B ( t ) ]}{\sqrt{max [ A ( t ) ⊗ A ( t ) ] \cdot max [ B ( t ) ⊗ B ( t ) ]}} \qquad [ Expression 1 ]$$

Here, the numerator in Expression 1 denotes the maximum value of the cross-correlation function by convolution integration between the function A(t) of the typical wave previously fetched and the function B(t) of the received wave. Moreover, the denominator is a square root of a value obtained by multiplying the maximum value of the self-correlation function of the function A(t) of the typical wave and the maximum value of the self-correlation function of the function B(t) of the received wave. According to Expression 1, the cross-correlation function between the function A(t) of the typical wave and the function B(t) of the received wave in the numerator can be standardized. Alternatively, as in Expression 2, setting can be changed so that the cross-correlation function between the function A(t) of the typical wave and the function B(t) of the received wave can be standardized by the self-correlation function of the function A(t) of the typical wave.

### Expression 2

$$E x p r e s s i o n 2 ; \frac{max [ A ( t ) ⊗ B ( t ) ]}{\sqrt{max [ A ( t ) ⊗ A ( t ) ]}} \qquad [ Expression 2 ]$$

For example, according to Expression 1, setting can be carried out so that a signal to the effect that the bubble generation is detected can be sent to the control circuit 13 when the maximum value of the cross-correlation function between the function A(t) of the typical wave and the function B(t) of the received wave exceeds a certain ratio set to the square root of the product of the maximum values of the self-correlation function of the function A(t) of the typical wave and the self-correlation function of the function B(t) of the received wave.

According to Expression 2, for example, when the maximum value of the cross-correlation function between the function A(t) of the typical wave and the function B(t) of the received wave exceeds a half of the maximum value of the self-correlation function of the function A(t) of the typical wave, setting is made possible so that the signal to the effect of detection of the bubble generation can be sent to the control circuit 13. Note that the ratio of the maximum value of the cross-correlation function to the maximum value of the self-correlation function can be set not only at half but also arbitrarily. With the signal to the effect of detection of the bubble generation taken as a trigger, exposure is allowed to continue for the continuous insonation time of the therapeutic ultrasound from the point of time of detection of the bubble generation, which is previously set by an operator such as a physician with the key input unit 15. Then, sending of the therapeutic ultrasound is finished.

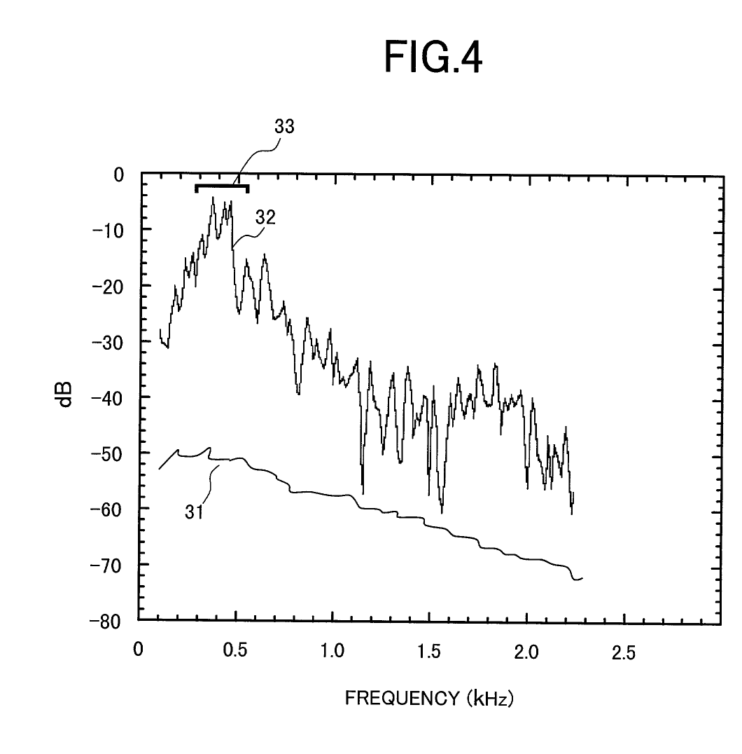

Moreover, in the signal processing unit 8, a received signal can be also subjected to FFT processing, then the received signal can be sent as an FFT spectrum to the wave analyzing unit 9. FIG. 4 shows one example of the FFT spectrum of a received sound fetched to the wave analyzing unit 9. In the graph, an axis of abscissas indicates frequencies, and an axis of ordinates indicates signal levels. A spectrum 31 before the start of irradiation of the therapeutic ultrasound and a spectrum 32 after the start of irradiation of the therapeutic ultrasound are always compared with each other in a detecting unit 23 of bubble generation. In one example, with regard to spectra before and during the treatment in a frequency range 33 of interest, which has been previously set between 250 to 550 Hz, values, each being obtained by integrating a signal intensity in the set frequency range for each preset sampling interval, are calculated in the detecting unit 23 of bubble generation. For each sampling interval, comparison thereof with a calculation result of the spectrum before the start of the treatment is carried out. Here, when a ratio obtained exceeds a preset ratio, the signal to the effect of detection of the bubble generation is sent to the control circuit 13. The frequency range 33 of interest can be freely altered by altering the setting of the detecting unit 23 of bubble generation, for example, can be altered in a range between 800 and 900 Hz. Alternatively, a constitution may be adopted, in which attention is paid to a particular frequency, signal intensities before and during the treatment are compared with each other to calculate a ratio thereof, and when the ratio exceeds a set value, the signal to the effect of detection of the bubble generation is sent out to the control circuit 13. With the signal to the effect of detection of the bubble generation taken as a trigger, exposure is allowed to continue for the continuous insonation time of the therapeutic ultrasound from the point of time of detection of the bubble generation, which is previously set by an operator such as a physician with the key input unit 15. Then, sending of the therapeutic ultrasound is finished.

Moreover, with regard to the received signal having been subjected to the FFT processing in the signal processing unit 8, a cross-correlation function thereof with a typical FFT waveform of the sound detected during the bubble generation, which is previously fetched, can be also obtained according to Expression 3 in the wave analyzing unit 9.

### Expression 3

$$E x p r e s s i o n 3 ; \frac{‖ a ( f ) \cdot b ( f ) ‖}{‖ a ( f ) ‖ \cdot ‖ b ( f ) ‖} \qquad [ Expression 3 ]$$

In Expression 3, the numerator denotes an absolute value of the cross-correlation function by convolution integration between a(f) and b(f) as FFT waveforms of the function A(t) of the typical wave, which is previously fetched, and the function B(t) of the received wave. Moreover, the denominator denotes a product of absolute values of a(f) and b(f).

Here, the frequency range 33 of interest can be arbitrarily set by use of suitable filtering processing, and in the frequency range 33 of interest, the cross-correlation function between the typical FFT waveform of the detected sound during the bubble generation and the FFT waveform of the sound received during the irradiation can be obtained.

From Expression 3, setting can be made variously for the ratio of the maximum value of the absolute value of the cross-correlation function between the FFT waveform function a(f) of the typical sound and the FFT waveform function b(f) of the received sound and the maximum value of the absolute value of the self-correlation function of a(f) or b(f). For example, when the maximum value of the absolute value of the cross-correlation function between a(f) and b(f) exceeds a certain ratio set with the maximum value of the absolute value of the self-correlation function of a(f), the signal to the effect of detection of the bubble generation is set to be sent to the control circuit 13, whereby the signal to the effect of detection of the bubble generation can be sent to the control circuit 13 when the maximum value of the absolute value of the cross-correlation function between a(f) and b(f) exceeds the set value. Alternatively, setting may be made to send the signal to the effect of detection of the bubble generation to the control circuit 13 also when the maximum value of the absolute value of the cross-correlation function between a(f) and b(f) exceeds a certain ratio set with the product of the maximum values of the absolute value of the self-correlation function of a(f) and the maximum value of the self-correlation function of b(f).

Note that an emergency stop switch 19 is provided between the control circuit 13 and the drive circuit 12 for a therapeutic ultrasound, whereby the operator can manually stop the irradiation of the therapeutic ultrasound.

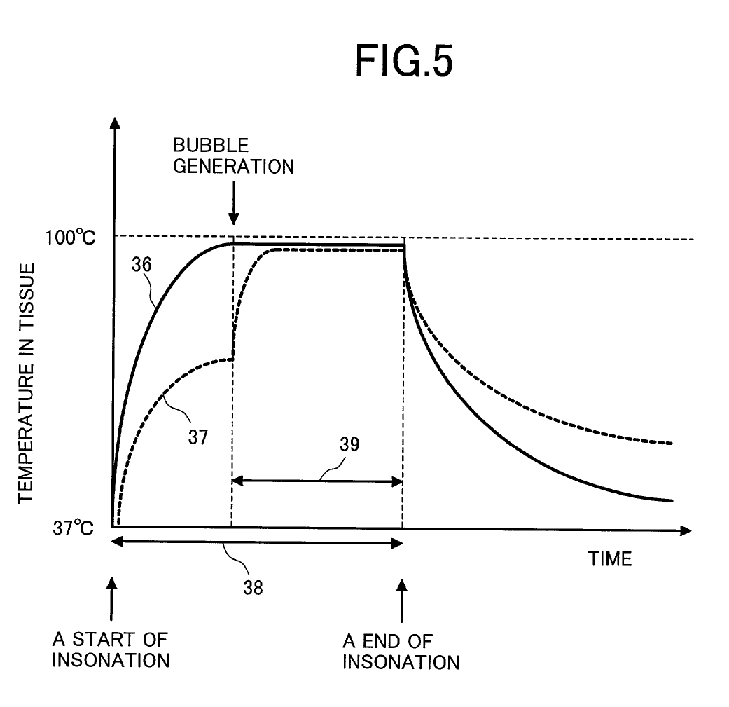

FIG. 5 is an explanatory view showing a temperature rise in the tissue by ultrasound irradiation. In FIG. 5, a temperature rise curve 36 indicates a change in temperature in the tissue in the vicinity of the focal point (including the focal point itself) of the irradiated ultrasound, and a temperature rise curve 37 indicates a change in temperature in the tissue at a position separate from the focal point of the irradiated ultrasound by 5 mm toward the applicator. When the intense therapeutic ultrasound is irradiated, as shown by the temperature rise curve 36, the temperature in the tissue in the vicinity of the focal point (including the focal point itself) of the irradiated ultrasound rises radically from about 37° C. of an initial tissue temperature of a living body to a temperature near 100° C. In this case, bubbles mainly composed of water vapor are radically generated inside the tissue. The bubbles radically generated are expanded in the narrow tissue, thus a sound including an audible sound range is generated. The sound detection microphone 3 in the therapeutic applicator detects the sound.

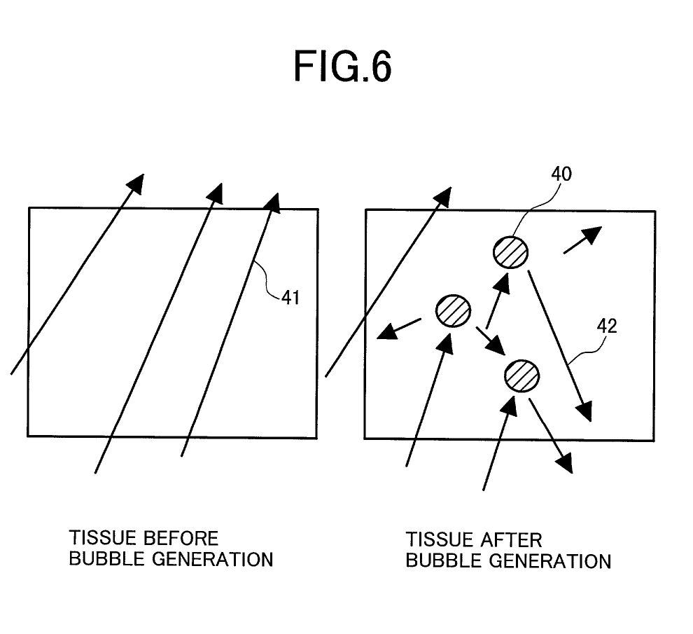

FIG. 6 is a schematic view for explaining propagation of the ultrasound in the tissue. The left drawing shows a state of the propagation before the bubbles are generated in the tissue, where a sent ultrasound 41 can continue to travel without being disturbed. Meanwhile, when the bubbles are generated in the vicinity of the focal point (including the focal point itself) of the irradiated ultrasound, as shown in the right drawing, a reflected ultrasound 42 is generated increasingly in the tissue where the bubbles 40 are generated since the bubbles 40 become intense reflectors of the ultrasound. Consequently, as represented by the temperature rise curve 37 in the tissue separate from the focal point of the irradiated ultrasound by 5 mm toward the applicator, which is shown in FIG. 5, temperature rise efficiency in the tissue separate from the focal point toward the applicator is significantly enhanced as compared with the case before the bubble generation, leading to enhancement of treatment efficiency after the bubble generation. Accordingly, from the point of time when the bubbles generated during the irradiation of the therapeutic ultrasound are detected, the irradiation of the therapeutic ultrasound is made to continue for a preset continuous insonation time 39 (refer to FIG. 5), whereby the state after the bubble generation can be utilized, in which the treatment efficiency is enhanced, without depending on a total insonation time 38.

Moreover, when the bubbles are generated in a spot to be treated, harmonics of the frequency of the therapeutic ultrasound irradiated on the bubbles are generated due to a nonlinear oscillation phenomenon of the bubbles. The ultrasound imaging probe 2 can receive the harmonics of the transmitted ultrasound. The harmonics such as second harmonics having a frequency twice the transmitted frequency are detected in a transmitting and receiving unit 26, made to pass through the signal processing unit 25, and stored in a frame memory 24 as a signal representing a generation position and a generation intensity of the ultrasound including the detected harmonics. This signal is displayed on a screen of a monitor 14 so as to be superposed on an echo image. Consequently, it is made possible to two-dimensionally observe distribution of the bubbles generated in the region to be treated. Hence, the intensity of the harmonics detected from the treated region is monitored, which has been previously set by use of the input unit 15, and determination is made that the point of time when the signal intensity of the harmonics reaches the set value or more is the point of time when the bubbles are generated, thus an irradiation command for the preset continuous insonation time can be sent from the control circuit 13 to the drive unit for the therapeutic ultrasound similarly to the bubble detection by use of the sound detection microphone 3.

Furthermore, the control circuit 13 has a function of graphically displaying the signal intensity of the harmonics on an arbitrary point displayed on the screen of the monitor 14, where a measurement result of the ultrasound reflection intensity of the bubbles in a spot desired by the operator such as a physician can be displayed. Moreover, the display function for the signal intensity of the harmonics can cause a color change on the display in the case where the intensity of the observed signal reaches an extent in an arbitrary intensity ratio with a reference signal intensity by previously setting reference intensity. Thus, the change in the signal intensity of the treated region can be visually transmitted to the operator such as a physician.

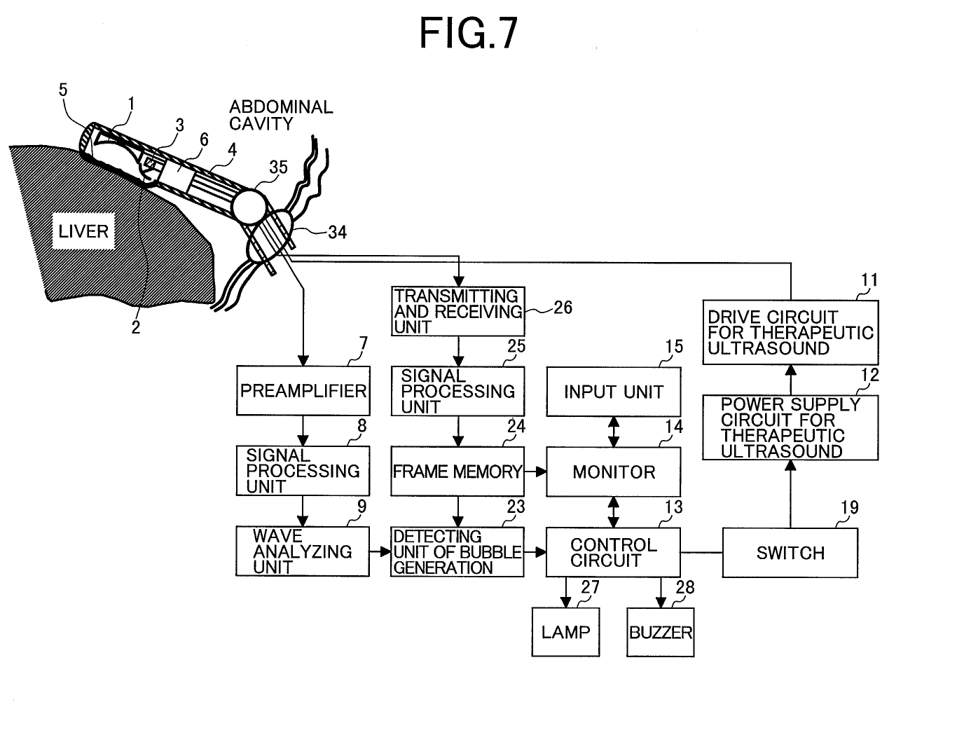

Next, description will be made for an embodiment, in which the present invention is applied to hepatoma treatment, with reference to FIG. 7. In FIG. 7, the same reference numerals as those in FIG. 1 denote the same functional units as those in FIG. 1.

In this embodiment, under an endoscopic surgery, a therapeutic applicator can be adjusted so as to be inserted from a fixing tool 34 for an endoscope insertion opening, which is formed in an abdominal wall, into an abdominal cavity, and to be brought into contact with a liver surface by a hinge 35. By use of the ultrasound imaging probe 2, the inside of the liver is observed, and alignment is carried out for the irradiation of the therapeutic ultrasound, then the therapeutic ultrasound is irradiated plural times, for example, so as to cover the region of the hepatoma.

As described in the embodiment of the prostate treatment, the sound detection microphone 3 detects an audio component composed mainly of an audible sound caused when the bubbles generated in the affected area are expanded to burst or when the bubbles destroy the tissue. Such an audio signal having passed through the preamplifier 7 is sent to the signal processing unit 8, where the signal is subjected to signal processing as below.

The waveform shown in FIG. 3 is one example of the time base waveform of the sound received during the bubble generation. The sound received is subjected to suitable filtering processing and time cutting out processing in the signal processing unit 8. Then, in the waveform analyzing unit 9, by use of the foregoing Expression 1, obtained is a cross-correlation function between the waveform of the sound processed and a typical waveform of a sound detected during the generation of bubbles, which has been previously fetched. Alternatively, as in the Expression 2, it is also possible to change the setting so as to standardize the cross-correlation function between the function A(t) of the typical wave and the function B(t) of the received wave by the self-correlation function of the function A(t) of the typical wave.

For example, according to the Expression 1, setting can be carried out so that a signal to the effect of detection of the bubble generation can be sent to the control circuit 13 when the maximum value of the cross-correlation function between the function A(t) of the typical wave and the function B(t) of the received wave exceeds a certain ratio set to the square root of the product of the maximum values of the self-correlation function of the function A(t) of the typical wave and the self-correlation function of the function B(t) of the received wave.

Alternatively, according to the Expression 2, when the maximum value of the cross-correlation function between the function A(t) of the typical wave and the function B(t) of the received wave exceeds, for example, a half of the maximum value of the self-correlation function of the function A(t) of the typical wave, setting is made possible so that the signal to the effect of detection of the bubble generation can be sent to the control circuit 13. Note that the ratio of the maximum value of the cross-correlation function to the maximum value of the self-correlation function can be set not only at half but also arbitrarily. With the signal to the effect of detection of the bubble generation taken as a trigger, exposure is allowed to continue for the continuous insonation time of the therapeutic ultrasound from the point of time of detection of the bubble generation, which is previously set by the operator such as a physician with the key input unit 15. Then, sending of the therapeutic ultrasound is finished.

Moreover, in the signal processing unit 8, a received signal can be also subjected to FFT processing, then the received signal can be sent as an FFT spectrum to the wave analyzing unit 9. FIG. 4 shows one example of the FFT spectrum of a received sound fetched to the wave analyzing unit 9. In the graph, an axis of abscissas indicates frequencies, and an axis of ordinates indicates signal levels. A spectrum 31 before the start of irradiation of the therapeutic ultrasound and a spectrum 32 after the start of irradiation of the therapeutic ultrasound are always compared with each other in a detecting unit 23 of bubble generation. In one example, with regard to spectra before and during the treatment in a frequency range 33 of interest, which has been previously set between 250 to 550 Hz, values, each being obtained by integrating a signal intensity in the set frequency range for each preset sampling interval, are calculated in the detecting unit 23 of bubble generation. For each sampling interval, comparison thereof with a calculation result of the spectrum before the start of the treatment is carried out. Here, when a ratio obtained exceeds a preset ratio, the signal to the effect of detection of the bubble generation is sent to the control circuit 13. The frequency range 33 of interest can be freely altered by altering the setting of the detecting unit 23 of bubble generation, for example, can be altered in a range between 800 and 900 Hz. Alternatively, a constitution may be adopted, in which attention is paid to a particular frequency, signal intensities before and during the treatment are compared with each other to calculate a ratio thereof, and when the ratio exceeds a set value, the signal to the effect of detection of the bubble generation is sent out to the control circuit 13. With the signal to the effect of detection of the bubble generation taken as a trigger, exposure is allowed to continue for the continuous insonation time of the therapeutic ultrasound from the point of time of detection of the bubble generation, which is previously set by an operator such as a physician with the key input unit 15. Then, sending of the therapeutic ultrasound is finished.

Moreover, with regard to the received signal having been subjected to the FFT processing in the signal processing unit 8, a cross-correlation function thereof with a typical FFT waveform of the sound detected during the bubble generation, which is previously fetched, can be also obtained according to the foregoing Expression 3 in the wave analyzing unit 9.

Here, the frequency range 33 of interest can be arbitrarily set by use of suitable filtering processing, and in the frequency range 33 of interest, the cross-correlation function between the typical FFT waveform of the detected sound during the bubble generation and the FFT waveform of the sound received during the irradiation can be obtained.

From Expression 3, setting can be made variously for the ratio of the maximum value of the absolute value of the cross-correlation function between the FFT waveform function a(f) of the typical sound and the FFT waveform function b(f) of the received sound and the maximum value of the absolute value of the self-correlation function of a(f) or b(f). For example, when the maximum value of the absolute value of the cross-correlation function between a(f) and b(f) exceeds a certain ratio set with the maximum value of the absolute value of the self-correlation function of a(f), the signal to the effect of detection of the bubble generation is set to be sent to the control circuit 13, whereby the signal to the effect of detection of the bubble generation can be sent to the control circuit 13 when the maximum value of the absolute value of the cross-correlation function between a(f) and b(f) exceeds the set value. Alternatively, setting may be made to send the signal to the effect of detection of the bubble generation to the control circuit 13 also when the maximum value of the absolute value of the cross-correlation function between a(f) and b(f) exceeds a certain ratio set with the product of the maximum values of the absolute value of the self-correlation function of a(f) and the maximum value of the self-correlation function of b(f).

With the signal to the effect of detection of the bubble generation taken as a trigger, exposure of the therapeutic ultrasound is allowed to continue for the preset continuous insonation time. Then, the exposure of the therapeutic ultrasound is finished. As described above, the intensity of the harmonics in the frequency of the therapeutic ultrasound is monitored, which is detected from the region to be treated by use of the ultrasound imaging probe 2, and determination is made that the point of time when the intensity reaches the set value or more is the point of time of the bubble generation, thus the signal to the effect of detection of the bubble generation can be also generated.

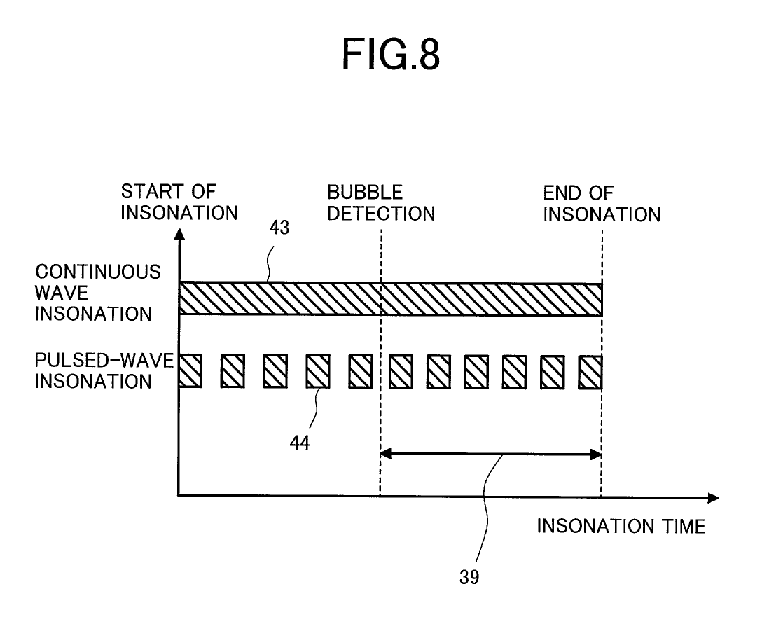

FIG. 8 is a view showing a method for irradiating a therapeutic ultrasound. The method for irradiating a therapeutic ultrasound can be broadly divided into continuous wave irradiation 43 and pulsed-wave irradiation 44. The continuous wave irradiation is a method for irradiating a wave continuously, for example, 10 seconds per once. The pulsed-wave irradiation is a method of repeating 1-second-irradiation and 0.2-second-nonirradiation. In the former case, for example, when the bubbles are generated at the point of 5 second-passage from the start of irradiation, in the case where the ultrasound imaging probe 2 is affected by the transmission of the therapeutic ultrasound by any chance, it is effective to use the sound detection microphone 3 mainly for an audible sound in order to detect the bubbles. Moreover, in the latter case, for example, in the case of repeating the 1-second-irradiation and the 0.2-second-nonirradiation, the ultrasound imaging for the affected area can be performed more accurately than in the former case by utilizing that 0.2 second of nonirradiation. Consequently, the generation of the bubbles can be detected by the sound detection microphone 3, and simultaneously, the generation of the bubbles can be detected from the harmonics originating from the bubbles, and thus the distribution of the bubbles can be displayed as a two-dimensional image on the monitor 14. In the case of the latter irradiation method, monitoring can be made to continue for the ultrasound reflection intensity of the affected area even during the treatment. When the reflection intensity of the ultrasound comes off the preset certain range, a blink of a lamp 27 and generation of an alarm by a buzzer 28 in FIG. 1 or FIG. 7 assist a quick action of the operator such as a physician. Moreover, as described above, the emergency stop is made possible by the will of the operator.

Particularly, in the case of frequent irradiation of the ultrasound, which is frequently used in the actual treatment mode, the alarm function can operate effectively. Specifically, in the period of time during the irradiation and the irradiation, the reflection intensity of the ultrasound including the harmonics such as second harmonics in the treated region is stored, whereby comparison thereof can be made with the ultrasound reflection intensity after the next irradiation, thus facilitating an alarm to be given in the case where a change rate of the ultrasound intensity exceeds the preset range.

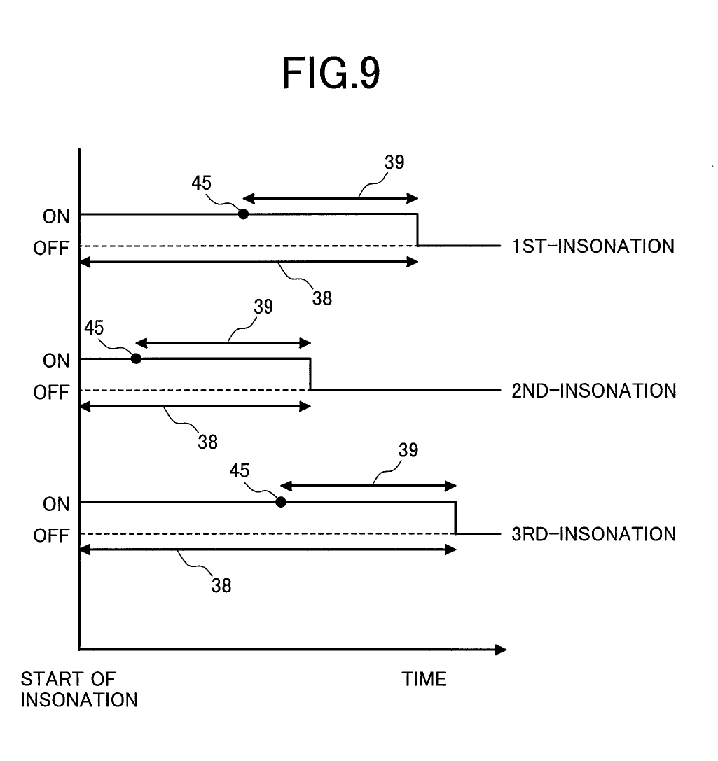

Here, consideration is made for the case where the irradiation of the therapeutic ultrasound is carried out plural times with reference to FIG. 9. Then, since the temperature rise of the peripheral tissue due to the previous exposure cannot be ignored, and since the tissues to be exposed are different from each other, conditions where the bubbles are generated in the focal point region differ from one to another even with the same ultrasound intensity and the same irradiation time. For example, in the example shown in FIG. 9, irradiation is carried out three times from the first time to the third time. Here, with regard to the period of time from the start of irradiation to the bubble detection 45, the period at the second irradiation is shorter than that at the first irradiation. Meanwhile, at the third irradiation, the period taken for the bubble detection 45 is longer than that at the first irradiation. Even if the period taken for each bubble generation is different from those of the others as described above, according to the present invention, the same continuous insonation time 39 taken from the time point of the bubble detection 45 is set, whereby the continuous insonation time from the bubble generation can be equalized among the respective irradiations without depending on the total insonation time 38, thus enabling the emerging thermal coagulation effect to be constant.

What is claimed is:

1. A therapeutic ultrasound system, comprising:
an ultrasonic transducer for irradiating a therapeutic ultrasound on a region to be treated;
setting-up means for setting up an insonation time of said therapeutic ultrasound; and
bubble detecting means for detecting a bubble caused in a region exposed with said therapeutic ultrasound during exposure of said therapeutic ultrasound,
wherein said setting-up means has a function of setting up a time from detection of the bubble by said bubble detecting means to the end of the exposure of said therapeutic ultrasound.

2. The therapeutic ultrasound system according to claim 1,
wherein said bubble detecting means has means for detecting an acoustic wave having a frequency twice a center frequency of said therapeutic ultrasound transmitted from said ultrasonic transducer.

3. The therapeutic ultrasound system according to claim 2, further comprising:
means for generating an alarm when received signal intensity of harmonics of said therapeutic ultrasound reaches a set value or more.

4. A therapeutic ultrasound system, comprising:
an ultrasonic transducer for irradiating a therapeutic ultrasound on a region to be treated; and
means for detecting an audible sound generated in a region exposed with said therapeutic ultrasound during exposure of said therapeutic ultrasound.

5. The therapeutic ultrasound system according to claim 4,
wherein a function of setting up a time from detection of said audible sound to the end of the exposure of said therapeutic ultrasound is provided.
